(19) United States
(12) Patent Application Publication
(10) Pub. No.: US 2025/0206267 A1
(43) Pub. Date: Jun. 26, 2025

(54) CLEANING SYSTEM FOR A VEHICLE AND VEHICLE

(71) Applicant: Robert Bosch GmbH, Stuttgart (DE)

(72) Inventors: Adam Ugron, Budapest (HU); Alan Pfetzer, Buehl (DE); Alexander Dudek, Offenburg (DE); Anisha Saxena, Hirschberg (DE); Godelieve Kraemer, Huegelsheim (DE)

(21) Appl. No.: 18/976,516

(22) Filed: Dec. 11, 2024

(30) Foreign Application Priority Data
Dec. 20, 2023 (DE) 10 2023 212 994.9

(51) Int. Cl. B60S 1/52; B60S 1/54

(52) U.S. Cl. CPC B60S 1/52; B60S 1/54

(57) ABSTRACT

A cleaning system for a vehicle includes a first medium unit, an acceleration unit, a second medium unit, a third medium unit, and a control unit. The first medium unit is configured to guide a first medium, in particular a cleaning agent, into the acceleration unit, the acceleration unit being configured to guide the first medium from the cleaning system in a predetermined fluidic flow via a first outlet opening, the second medium unit being configured to introduce a second medium, in particular a pressurized gas, into the fluidic flow via a second outlet opening, the third medium unit being configured to guide a third medium obliquely in the direction of the fluidic flow via a third outlet opening, and the control unit being configured to control a flow of the third medium in order to adjust a characteristic of the fluidic flow by the third medium.

### BACKGROUND

The present invention relates to a cleaning system for a vehicle and a vehicle comprising such a cleaning device.

There are currently a plurality of different solutions for cleaning surfaces in the vehicle sector. Due to the increasing number of surfaces to be cleaned on the vehicle and their sensors, the need for a cleaning fluid to be kept on hand is constantly increasing.

The constant weight reduction in the vehicle sector to reduce fuel consumption and increasing competition are putting pressure on costs, such that cheaper and more efficient components for vehicles are in greater demand.

### SUMMARY

Proposed according to a first aspect of the present invention is a cleaning system for a vehicle, in particular for a road vehicle such as a car, a truck, a bus, a van, etc. The cleaning system according to the invention has the advantage over the known system that the consumption of cleaning fluids can be significantly reduced. As a result, the frequency of refilling the cleaning fluid is reduced for the vehicle user. Furthermore, the dissolution of dirt and/or the cleaning effect can be improved by a combination of three media according to the invention. This combination of three media can also reduce the pressure of one or more media, which can result in less wear on the cleaning system and lower energy consumption of the cleaning system.

According to the invention, this is achieved by the cleaning system having a first medium unit, an acceleration unit, a second medium unit, a third medium unit, and a control unit. The first medium unit is in this case configured to guide a first medium, in particular a cleaning agent, into the acceleration unit, whereby the acceleration unit is configured to guide the first medium from the cleaning system in a predetermined fluidic flow via a first outlet opening.

Furthermore, the second medium unit is configured to introduce a second medium, in particular a pressurized gas, which can also represent a gas mixture (e.g., air), into the predetermined fluidic flow via a second outlet opening. It should be noted that the first outlet opening and the second outlet opening are preferably arranged next to one another essentially within a plane, so that respective flow directions of the first medium and the second medium are essentially identical when exiting the respective outlet openings, without thereby being restricted to undertake such an arrangement and/or alignment of the respective outlet openings.

In other words, the cleaning system for the vehicle is in particular a cleaning system which is arranged in the vicinity of a surface to be cleaned or is arranged in or on a wiper which is configured to clean the surface being cleaned. The surface of the vehicle being cleaned can in principle be any surface of the vehicle, but in particular an environmental interface of a vehicle sensor (e.g., an ultrasonic and/or radar and/or lidar sensor and/or a camera) and/or a surface of a vehicle window and/or a vehicle light. The first medium unit can preferably comprise a connector to a fluid system or a gas system, whereby the connector connects the first medium unit to a pump, and/or a compressor, and/or a valve, and/or a tank in order to convey the first medium into the first medium unit.

The first medium unit can be connected to the acceleration unit, or both can be designed to be integral. The first medium unit can also be fluidically connected to the acceleration unit. The acceleration unit preferably comprises an acceleration channel which forms a predetermined fluidic flow. Preferably, the predetermined fluidic flow can be formed from the first medium and/or the second medium. Preferably, the first medium is a liquid, and the second medium is a gas or a gas mixture. Furthermore, the first medium can be a gas or a gas mixture (e.g., air), and the second medium can be a liquid. Liquids also include liquid mixtures comprising solids. Further, the first medium can be a first fluid and the second medium can be a second fluid. In addition, the predetermined fluidic flow can be configured to clean a surface to be cleaned.

The predetermined fluidic flow can be specifically adjusted by means of the contour or design of the acceleration channel. Furthermore, the acceleration channel can form a nozzle that changes the material properties of the first medium and, e.g., atomizes it.

Preferably, the acceleration unit and the second medium unit are connected to each other when designed to be in multiple pieces, or they can have an integral design. The first medium and the second medium are preferably separated from each other until the first medium exits the acceleration unit and until the second medium exits the second medium unit. Only after the first medium exits the acceleration unit and the second medium exits the second medium unit are the first medium and the second medium preferably mixed together or the second medium is introduced into the first medium. The second medium unit can also comprise a connector to a pump, and/or a compressor, and/or a valve, and/or a tank in order to provide the second medium. The second medium unit can comprise a cavity receiving the second medium.

Preferably, a gap is arranged between the acceleration unit and the second medium unit, with the second medium unit discharging the second medium through the gap.

The third medium unit is configured to guide a third medium from the first medium and the second medium at an angle in the direction of the fluidic flow via a third outlet opening, whereby the third medium is preferably a gas or a gas mixture such as air, for example. For this purpose, the third medium unit preferably also comprises a connector to a pump, and/or a compressor, and/or a valve, and/or a tank in order to provide the third medium. It is also conceivable that the third medium is alternatively or additionally a fluid.

It should be noted in general that respective actuators (e.g., the pumps, compressors, valves, etc. specified hereinabove) for conveying the first medium, the second medium, and the third medium can be used at least partially together for conveying respective media if certain media are identically designed. For example, it is conceivable that, in a case where the second and third media are both air, the two media can be pressurized by means of the same compressor and controlled by means of independent valves downstream of the compressor. In addition, any other desired combinations of actuators are in principle conceivable, which are obvious to the skilled person skilled based on the respective combination of media.

It should also be pointed out in general that the respective geometries of the surfaces of the first, second, and third outlet openings can in principle be defined arbitrarily and independently of one another. In the case of an existing gap between the acceleration unit of the first medium unit and the second medium unit as described above, the first outlet opening has, for example, a circular opening surface, while the second outlet opening has, for example, an annular opening surface due to a gap surrounding the first outlet opening. In such a case, the third outlet opening also has a circular opening surface or a different one, for example a rectangular opening surface. It is also conceivable that the respective surfaces of the first, and/or the second, and/or the third outlet opening are elliptical, square, polygonal, star-shaped, crescent-shaped, or other shapes.

It is also not absolutely necessary for the second outlet opening to completely surround the first outlet opening. Instead, it is possible that it only partially surrounds the first outlet opening or is arranged adjacent to the first outlet opening.

The control unit is configured to control at least one flow of the third medium in order to adjust a characteristic of the fluidic flow by means of the third medium. For this purpose, the control unit is advantageously connected to an actuator (e.g., to the previously specified pump, the valve, or the compressor) in order to output the third medium. On this basis, the control unit is, e.g., configured to adjust a pressure, and/or a volumetric flow, and/or an output quantity, and/or a composition of the third medium.

In summary, the use of the third medium unit for adapting the fluidic flow from the first medium and the second medium offers the particular advantage that a surface to be cleaned can be cleaned particularly flexibly and, for example, adapted to current boundary conditions. As already described above, this also further reduces the need for a cleaning fluid to be kept in the vehicle because the surface can be cleaned in a particularly targeted manner.

The control unit is also preferably configured to control a flow of the first medium and/or a flow of the second medium. In particular, the control unit can be configured to control a flow of the first and/or the second and/or the third medium using a switching sequence. On the basis of such a switching sequence, it is possible on the one hand to output all media at the same time or to output only some of the media at the same time and to output the other part at different times (e.g., overlapping or non-overlapping). It can therefore be advantageous, for example, to first soften soiling on a surface of the vehicle to be cleaned by simultaneously outputting the first, second, and third media and then blow it away using only the second medium and/or the third medium (e.g., using air) such that the required amount of the first medium (e.g., a cleaning agent) can be reduced as a result. Alternatively, it is also conceivable that the first and/or the second medium and/or the third medium are output sequentially. In addition to purely activating and deactivating an output of the respective media, the control unit can also be configured to adjust a pressure and/or a flow rate of the respective media in addition to the switching sequence.

As already mentioned hereinabove, the cleaning system advantageously comprises a nozzle unit which is configured to accelerate and/or atomize the predetermined fluidic flow. One advantage of this embodiment can be that the cleaning effect of the cleaning system can be further improved by means of the nebulization of the predetermined fluidic flow because the nebulization of the first medium increases its surface area and can therefore potentially remove more dirt particles. In this way, it is also possible to reduce the required proportion of a cleaning agent if it is mixed with air, for example. In particular, the nozzle unit can be arranged on the second medium unit and/or designed to be integral with the second medium unit.

In one further advantageous embodiment of the present invention, the cleaning system further comprises a jet shaping unit, whereby the jet shaping unit surrounds the first outlet opening and the second outlet opening on an outer side of the cleaning system in order to shape or limit the spread of the fluidic flow generated by means of the first medium unit and by means of the second medium unit. For this purpose, the jet shaping unit is, for example, funnel-shaped or cylindrical or designed differently. It is also conceivable that the jet shaping unit be movably mounted on the cleaning system and configured to be swiveled and/or rotated by means of one or multiple actuators in order to additionally influence a shape and/or a direction of the fluidic flow based on the jet shaping unit. Particularly advantageously, the third outlet opening is arranged on the jet shaping unit and in particular on an inner side of the jet shaping unit, without being restricted to such an arrangement position.

In a further advantageous embodiment, the third medium unit is configured to indirectly guide the third medium onto the fluidic flow, in that the third medium is output in the direction of an inner surface of the jet shaping unit and is deflected in the direction of the fluidic flow upon contact with the inner surface. As a result, it is possible to, e.g., achieve greater flexibility in the arrangement of the third outlet opening and/or in influencing the characteristic of the fluidic flow.

Preferably, a main emission direction of the third medium from the third outlet opening crosses a main emission direction of the fluidic flow at an angle of 30° to 90°,preferably from 45° to 90° and more preferably from 60° to 90°, in order to enable a particularly effective influencing of the fluidic flow. Particularly advantageously, the third medium unit (in particular in conjunction with an actuator and the control unit) is configured to adjust a shape, and/or a size, and/or a direction of the fluidic flow. In this context, it is also conceivable that the third outlet opening be designed to be adaptable on the basis of a further actuator, so that a main emission direction and/or a shape and/or a size of an output jet of the third medium can be adapted in order to be able to influence the fluidic flow from the first and the second medium in an even more targeted manner.

In a particularly preferred embodiment of the present invention, the third medium unit comprises a plurality of third outlet openings, which are arranged in the vicinity of the first outlet opening and the second outlet opening. Advantageously, the control unit is configured to control an output of the third medium via the plurality of third outlet openings at least partially independently of one another. It should be noted that a size and/or a geometry of the respective third outlet openings can be identical or at least partially different for all third outlet openings. Furthermore, it is possible that the third outlet openings can be arranged to be equidistant from one another, and/or equidistant from the first, and/or equidistant from the second outlet opening, or can be arranged differently. Particularly advantageously, the control unit is configured on the basis of respective actuators to control an output of the third medium via the third outlet openings for each third outlet opening, independently of one another. This can, e.g., be implemented by supplying all third outlet openings with the third medium by means of one and the same pump, but with valves that can be controlled independently of each other by the control unit connected upstream of each outlet opening. The use of a large number of third outlet openings offers the particular advantage that the fluidic flow can be influenced particularly flexibly and/or precisely by means of the third medium. As a result, it is possible to, e.g., further increase the cleaning performance of the cleaning system, which can additionally reduce the need for a cleaning fluid, etc.

Further preferably, the control unit is configured to continuously change an output pressure of the third medium during a cleaning process in order to effect a continuous deflection and/or change in shape of the fluidic flow. As a result, the fluidic flow can be guided over the surface of the vehicle being cleaned in the form of a continuous wiping movement, for example, in order to remove dirt on the surface to be cleaned particularly effectively. This is done, for example, in conjunction with a supporting jet shaping of the fluidic flow by the third medium, by which the fluidic flow is guided over the surface to be cleaned in a fan shape, for example.

In a further preferred embodiment of the present invention, the control unit is configured to adapt the characteristic of the fluidic flow as a function of influencing variables currently acting on the fluidic flow and/or as a function of cleaning requirements currently present on the cleaning system. One influencing factor acting on the fluidic flow can, e.g., be a headwind which can deflect the fluidic flow from the surface being cleaned in an unfavorable way with regard to the desired cleaning effect. Such an unfavorable deflection of the fluidic flow can be at least partially compensated for by suitable control of the output of the third medium by means of the control unit. A current cleaning requirement for the cleaning system can, for example, relate to the degree of soiling of the surface to be cleaned, which is preferably detected by a sensor system in the vehicle. In this way, the output of the third medium can be specifically adapted to the respective degree of soiling. Alternatively or additionally, the cleaning requirement may vary depending on the current driving mode, as more thorough cleaning may be required for a vehicle sensor etc. in (partially) automated driving mode, for example, than in manual driving mode, in which there is additional control by a driver.

Proposed according to a second aspect of the present invention is a vehicle which comprises at least one cleaning system according to the first aspect of the invention and a surface to be cleaned by means of the cleaning system (e.g., a sensor surface, a vehicle windshield, a surface of a lighting device, etc.). The features, feature combinations, and the resulting advantages correspond to those explained in connection with the first aspect of the invention specified in the introductory section are clear enough that reference will be made to the explanations hereinabove in order to avoid repetitions.

### BRIEF DESCRIPTION OF THE DRAWINGS

In the following, exemplary embodiments of the invention are described in detail with reference to the accompanying drawings. The drawings show:

FIG. 1 an exemplary embodiment of a cleaning system according to the invention;

FIG. 2 a further exemplary embodiment of the cleaning system according to the invention in connection with a surface to be cleaned; and

FIG. 3 an exemplary embodiment of a vehicle according to the invention.

### DETAILED DESCRIPTION

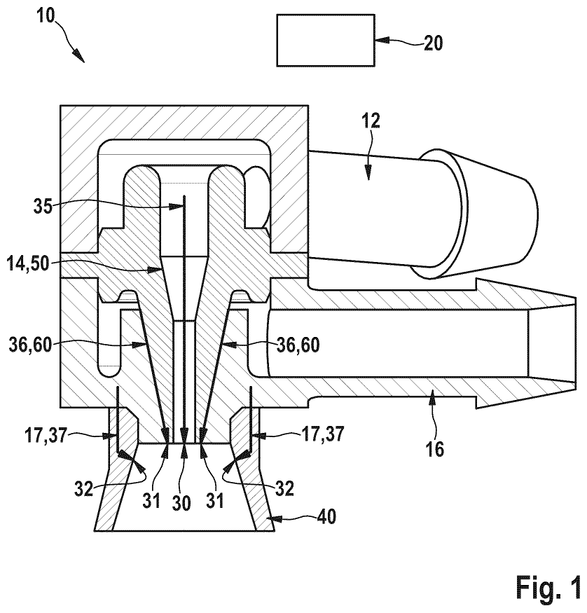

FIG. 1 shows an exemplary embodiment of a cleaning system 10 according to the invention for a vehicle 100 (see FIG. 3), whereby the cleaning system 10 comprises a first medium unit 12, an acceleration unit 14, a second medium unit 16, a third medium unit 17, and a control unit 20.

The first medium unit 12 is configured to feed a first medium, which in this case is a cleaning fluid, into the acceleration unit 14. For this purpose, the first medium unit 12 is connected via a tube (not shown) to a fluid system (not shown), which has a reservoir (not shown) for the cleaning fluid.

The acceleration unit 14, which in this case comprises a nozzle unit 50, is configured to guide the first medium in a predetermined fluidic flow 18 from the cleaning system 10 via a first outlet opening 30, while the second medium unit 16 is configured to introduce a second medium, which in this case is air, into the fluidic flow 18 via a second outlet opening 31.

For this purpose, the second medium unit 16 forms a gap between itself and the first medium unit 12 in order to introduce the air into the fluidic flow 18 in the immediate vicinity of the first outlet opening 30.

The third medium unit 17 is configured to guide a third medium, which in this case is also air, via a plurality of third outlet openings 32 obliquely at an angle of 45° to 90° with respect to a main emission direction of the fluidic flow 18 in the direction of the fluidic flow 18. The respective third outlet openings 32 are in this case arranged on an inner side of a jet shaping unit 40 of the cleaning system 10, whereby the jet shaping unit 40 is provided for spatially limiting and thereby shaping the fluidic flow 18.

It should be noted that the third medium unit 17 or the respective air conducting channels of the third medium unit 17 are only indicated herein for reasons of clarity. The air conducting channels can, for example, comprise tubular connectors in the area of the jet shaping unit 40 and/or a further component of the cleaning system 10 in order to be connected via these to the first valve (not shown).

The control unit 20, which is in this case designed as a microcontroller, is configured to control a flow 37 of the third medium via the respective third outlet openings 32 in order to adjust a direction of emission and a shape of the fluidic flow 18 by means of the third medium.

For this purpose, the control unit 20 is connected via information technology to a compressor (not shown) and the first valve in order to build up a suitable air pressure by means of the compressor and to transport the compressed air to the third outlet openings 32 by means of a control for opening the first valve via the third medium unit 17, which is connected to the first valve by means of a tube.

The control unit 20 is further configured, in conjunction with corresponding actuators (e.g., a second valve via which the compressed air generated by the compressor is transported to the second medium unit 16 and a pump via which the cleaning fluid is transported to the first medium unit 12), to additionally control a flow 35 of the first medium and/or a flow 36 of the second medium in order to be able to adapt a cleaning performance of the cleaning system 10 to current boundary conditions.

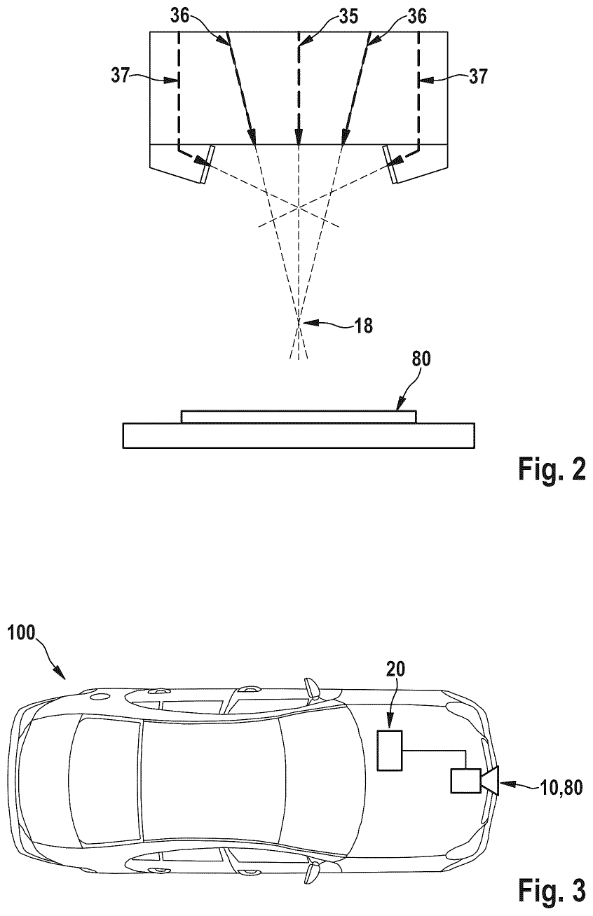

FIG. 2 shows a further exemplary embodiment of the cleaning system 10 according to the invention in conjunction with a surface 80 to be cleaned, which in this case is a protective glass of a lidar sensor.

FIG. 2 illustrates the respective flows 35, 36 and 37 of first, second, and third media within the cleaning system 10 and the output directions of the respective media when leaving the cleaning system 10.

By means of a suitable control of the flow 37 of the third medium (in this case air), a deflection of the fluidic flow 18 with respect to the surface 80 to be cleaned can be achieved in order to increase a cleaning performance and to reduce a consumption of a cleaning fluid, which represents the first medium.

FIG. 3 shows an exemplary embodiment of a vehicle 100 according to the invention comprising a cleaning system 10 according to the invention, which is in this case provided for cleaning an environmental sensor 80 of the vehicle 100. The environmental sensor 80 and the cleaning system 10 are connected in terms of information technology to a control unit 20 of the vehicle, which is configured to determine a degree of soiling of an environmental interface (i.e., a measuring interface) of the environmental sensor 80 via a signal from the environmental sensor 80 and, depending on the degree of soiling, to actuate respective actuators (not shown) of the cleaning system 10 in order to achieve a fluidic flow 18 (see FIG. 1 or FIG. 2) generated by the cleaning system 10 for cleaning the environmental sensor 80.

1. A cleaning system (10) for a vehicle (100), the system comprising:
a first medium unit (12),
an acceleration unit (14),
a second medium unit (16),
a third medium unit (17), and
a control unit (20),
wherein
the first medium unit (12) is configured to guide a first medium into the acceleration unit (14),
the acceleration unit (14) is configured to guide the first medium in a predetermined fluidic flow (18) out of the cleaning system (10) via a first outlet opening (30),
the second medium unit (16) is configured to introduce a second medium into the fluidic flow (18) via a second outlet opening (31),
the third medium unit (17) is configured to guide a third medium obliquely in the direction of the fluidic flow (18) via a third outlet opening (32), and
the control unit (20) is configured to control a flow (37) of the third medium in order to adjust a characteristic of the fluidic flow (18) by the third medium.

2. The cleaning system (10) according to claim 1, wherein the control unit (20) is configured to:
control a flow (35) of the first medium and/or a flow (36) of the second medium, and/or
control a flow (35, 36, 37) of respective media by a switching sequence.

3. The cleaning system (10) according to claim 1, wherein the cleaning system (10) comprises a nozzle unit (50), wherein the nozzle unit (50) is configured to atomize the predetermined fluidic flow (18).

4. The cleaning system (10) according to claim 1, further comprising a jet shaping unit (40), wherein
the jet shaping unit (40) surrounds the first outlet opening (30) and the second outlet opening (31) on an exterior of the cleaning system (10) in order to shape the fluidic flow (18) generated by the first medium unit (12) and the second medium unit (16), and/or
the third outlet opening (32) is arranged on the jet shaping unit (40).

5. The cleaning system (10) according to claim 4, wherein the third medium unit (17) is configured to guide the third medium indirectly onto the fluidic flow (18) by the third medium being emitted in a direction of an inner surface of the jet shaping unit (40) and being deflected in the direction of the fluidic flow (18) upon contact with the inner surface.

6. The cleaning system (10) according to claim 1, wherein
a main emission direction of the third medium from the third outlet opening (32) crosses a main emission direction of the fluidic flow (18) at an angle from 30° to 90°, and/or
the third medium unit (17) is configured to adapt a shape, and/or a size, and/or a direction of the fluidic flow (18).

7. The cleaning system (10) according to claim 1, wherein
the third medium unit (17) comprises a plurality of third outlet openings (32), which are arranged in proximity to the first outlet opening (30) and the second outlet opening (31), and/or
the control unit (20) is configured to control an output of the third medium via the plurality of third outlet openings (32), at least partially independently of one another.

8. The cleaning system (10) according to claim 1, wherein the control unit (20) is configured to continuously change an output pressure of the third medium during a cleaning process in order to effect a continuous deflection and/or change in shape of the fluidic flow (18).

9. The cleaning system (10) according to claim 1, wherein the control unit (20) is configured to control the characteristic of the fluidic flow (18) as a function of:
influencing variables currently acting on the fluidic flow (18), and/or
the current cleaning requirements for the cleaning system (10).

10. A vehicle (100) comprising at least one cleaning system (10) according to claim 1 and a surface (80) to be cleaned by the cleaning system (10).

11. The cleaning system (10) according to claim 1, wherein the first medium is a cleaning agent and the second medium is a pressurized gas.

12. The cleaning system (10) according to claim 4, wherein the third outlet opening (32) is arranged on an inner side of the jet shaping unit (40).

13. The cleaning system (10) according to claim 6, wherein the main emission direction of the third medium from the third outlet opening (32) crosses a main emission direction of the fluidic flow (18) at an angle from 45° to 90°.

14. The cleaning system (10) according to claim 13, wherein the main emission direction of the third medium from the third outlet opening (32) crosses a main emission direction of the fluidic flow (18) at an angle from 60° to 90°.
